(19) United States
(12) Patent Application Publication
(10) Pub. No.: US 2025/0360855 A1
(43) Pub. Date: Nov. 27, 2025

(54) ADJUSTABLE HEAD AND NECK SUPPORT, AND VEHICLE SEAT

(71) Applicant: Brose Fahrzeugteile SE & Co. Kommanditgesellschaft, Coburg, Coburg (DE)

(72) Inventors: Jonas SCHELER, Bad Rodach (DE); Sandra KIESER-NEUMEYER, Coburg (DE)

(21) Appl. No.: 19/214,314

(22) Filed: May 21, 2025

(30) Foreign Application Priority Data
May 21, 2024 (DE) 10 2024 204 689.2

(51) Int. Cl. B60N 2/853; B60N 2/821; B60N 2/829; B60N 2/865

(52) U.S. Cl. CPC B60N 2/853; B60N 2/821; B60N 2/829; B60N 2/865

(57) ABSTRACT

An adjustable head and neck support has a common adjustment mechanism by which a coupled movement of a head support area and a neck support area is enabled. The adjustment mechanism is configured in such a way that, on the one hand, a linear, joint height adjustment of the head support area and the neck support area in a Z direction is enabled and, on the other hand, alternatively, only a swivel adjustment of at least the neck support area is enabled, so that the neck support area can be swiveled forward in the direction of a user. The adjustment mechanism is embodied in particular as an asymmetrically configured toggle lever mechanism. This allows for easy adjustment of the head and neck support.

### CROSS-REFERENCE TO RELATED APPLICATION

This application claims the priority, under 35 U.S.C. § 119, of German Patent Application DE 10 2024 204 689.2, filed May 21, 2024; the prior application is herewith incorporated by reference in its entirety.

### FIELD AND BACKGROUND OF THE INVENTION

The invention relates to an adjustable head and neck support with a head support area and with a neck support area, a common adjustment mechanism being formed by means of which a coupled movement of the head support area and the neck support area is possible.

Such an adjustable head and neck support is known, for example, from published, non-prosecuted German patent application DE 10 2013 000 163 A1, corresponding to U.S. Pat. No. 9,517,708. There, an adjustment mechanism is described in which a headrest is height-adjustable as a separate unit along guide rods. A spindle drive engages on a cross member. This can be coupled to a second cross member via a lever, which in turn is connected to a neck support as a second separate unit via a lever mechanism. In a coupled movement—i.e., when the two cross members are moved together in a Z direction via the lever—the lever mechanism actuates the headrest so that it is swiveled forward.

An adjustment device, for example of a lumbar support, is known from published, non-prosecuted German patent application DE 10 2016 207 620 A1, corresponding to U.S. Pat. No. 10,960,788, in which the lumbar support is connected to a toggle lever mechanism. The two toggle levers of the toggle mechanism are each connected to a slider that can be moved in a Z direction and can each be driven separately with its own spindle drive, allowing for either a height adjustment in the Z direction or a forward adjustment in the X direction.

Another adjustable head and neck support is known, for example, from published, non-prosecuted German patent application DE 10 2019 123 680 A1 corresponding to U.S. Pat. No. 11,807,144. In that case, a neck support embodied as a separate unit can be extended in the X direction toward a user.

### SUMMARY OF THE INVENTION

Taking this as a point of departure, it is the object of the invention to provide an improved head and neck support with a simple adjustment mechanism.

The object is achieved according to the invention by an adjustable head and neck support and by a vehicle seat with such an adjustable head and neck support. The head and neck support has a head support area and a neck support area and an adjustment mechanism which enables a coupled movement of the head support area and the neck support area. The adjustment mechanism is configured in such a way that, on the one hand, a preferably linear, joint height adjustment of the head support area and the neck support area in a Z direction is enabled and, on the other hand, only a swivel adjustment of at least one of the two areas selected from among the neck support area and the head support area is enabled, particularly in such a way that, after the swivel adjustment has been carried out, the neck support area is oriented forward in the direction of a user who is located in the vehicle seat.

Preferably, at least the neck support area can be swiveled toward the user. Alternatively or in addition to swiveling the neck support area, the head support area is swiveled backward, i.e., away from the user. After the swivel adjustment, either the neck support area is swiveled forward and/or a relative movement takes place between the neck support area and the head support area, so that—compared to a situation before the swiveling movement—the neck support area is oriented farther forward toward the user.

For the height adjustment, a mechanical guide, e.g., a guide rail or guide rod, is provided along which the height adjustment takes place.

Depending on the controlling of the adjustment mechanism, either one of these two independent movements (swivel adjustment on the one hand and height adjustment on the other) or a combination, i.e., an overlay of these two movements, can be carried out.

It should be emphasized, on the one hand, that during the joint height adjustment, the two support areas each perform a particularly linear movement, so that no swiveling movements are required or provided for the (pure) height adjustment. Also, with this (pure) height adjustment, there is no adjustment in an X direction, i.e., in the direction of a user sitting in the vehicle seat. This allows for good and easy adjustment to different user body sizes.

Such a joint, in particular linear, height adjustment in the Z direction is not possible, for example, in the known design according to published, non-prosecuted German patent application DE 10 2013 000 163 A1. In that case, a complex movement with rotational components is required in order to adjust the height of the neck support, which is coupled with the height adjustment of the head support. A pure height adjustment without a feed motion is not possible-unlike with the design described herein.

Height adjustment in the Z direction is generally understood to mean an adjustment in a direction in which the distance to a seat surface of the vehicle seat changes. The Z direction is usually oriented in a vertical direction or slightly inclined to the vertical direction and runs, for example, parallel to a backrest.

It is also crucial that, in addition to this adjustment movement in the Z direction, but if necessary independently thereof, the swiveling movement of at least the neck support area be enabled. This means that the neck support area is pivoted around a horizontal axis of rotation which preferably runs above the neck support area. The axis of rotation is defined in particular by a swivel bearing. As a result, the neck support area moves along a curved path of movement, in particular along a circular path, so that the neck support area is moved forward in the X direction and thus specifically supports the user's neck. During this swiveling movement, the neck support area also changes its position in the Z direction. The swiveling movement generally changes the angle of inclination of the neck support area with respect to the Z direction.

The swiveling movement makes targeted support of the neck area possible, for example in a comfortable or resting position.

The neck support area preferably has a support which is provided with a cushion, for example. By virtue of the swiveling movement around the described axis of rotation, this support changes its angular orientation with respect to the Z direction.

The advantage of this swiveling movement is particularly evident in a one-piece design of the head and neck support in which the head support area and the neck support area form a common, one-piece unit that is moved together. Therefore, both a head cushion and a neck cushion are attached to the afore-described support, which can also be part of a common one-piece cushion. The neck cushion is typically located below the head cushion.

In one expedient embodiment, the head support area and the neck support area are therefore also formed in one piece and thus embodied as a common structural unit through which a combined support unit is formed. In particular, this has the afore-described common support.

However, the adjustment mechanism can also be combined with versions in which the neck support area and the head support area are formed by separate units that are only connected to each other via the common adjustment mechanism. The separate units each have, for example, a support with cushion attached thereto.

Preferably, the adjustment mechanism is linked at least indirectly to the combined support unit via only a single linkage area and via a swivel bearing. For the height adjustment in the Z direction, the linkage area and swivel bearing can be moved together in the Z direction. For the swivel adjustment, the linkage area can be moved forward, and the combined support unit is swiveled around the swivel bearing. Therefore, for these two types of movement, only one common adjustment mechanism is provided which preferably acts directly or indirectly on the combined support unit only in the linkage area. In the linkage area, one or more support points or articulation points can be formed via which the adjustment mechanism is at least indirectly supported on the combined support unit or is connected thereto.

An indirect connection is understood here to mean that an additional structural unit can be arranged between the linkage area and the combined support unit, in particular the support thereof, so that the articulation of the adjustment mechanism takes place on this structural unit. This structural unit is then supported by the combined support unit, in particular by the support.

Preferably, however, the adjustment mechanism with the linkage area is supported directly on the combined support unit, in particular on the support thereof.

Preferably, the adjustment mechanism is generally only loosely supported on the combined support unit, meaning that it is not fixedly connected thereto at the linkage area.

In a preferred embodiment, the adjustment mechanism has a toggle lever mechanism with two toggle levers that are connected to each other at a toggle joint. Each toggle lever is hingedly supported on an adjustment element. This design makes the adjustment mechanism comparatively simple overall. In particular, it only has the toggle lever mechanism with only two toggle levers. The toggle joint is supported at least indirectly by the head and neck support, particularly by the neck support area and especially by the combined support part. In particular, the toggle joint is supported at least indirectly on the afore-described support. The support is provided at the afore-described linkage area.

The adjustment elements can be moved in particular along a linear guide in the Z direction. The linear guide therefore extends in the Z direction and the adjustment elements are arranged thereon in a suitably displaceable manner, in particular slidingly supported thereon. The linear guide is a guide rod, for example.

Preferably, two linear guides, on each of which a toggle lever mechanism with two adjustment elements is mounted, are mounted opposite one another in the transverse direction. Alternatively, only one central toggle lever mechanism is formed.

For the joint height adjustment, the adjustment elements can be moved together in the Z direction. The two adjustment elements are therefore moved together along the linear guide while maintaining their distance, so that overall a pure height adjustment is achieved.

For the swivel adjustment and thus also the tilt adjustment, the two adjustment elements can also be moved independently of each other in the Z direction, so that the distance between them can be varied. During such a movement sequence, the toggle lever mechanism is actuated and activated, so that the position of the toggle joint changes.

With regard to the desired swiveling movement, the toggle lever mechanism preferably has an asymmetrical design. This means that the two toggle levers have different lengths. In particular, an upper toggle lever is longer than a lower toggle lever. This ensures that, when the toggle lever mechanism is actuated, a lower area and thus the neck support area is specifically moved forward and thus in the X direction.

In one expedient refinement, the toggle joint, especially in the variant with the common support unit, is asymmetrical and in particular linked at least indirectly to a lower portion, for example in a lower third of this common support unit. Particularly in combination with the asymmetrical design of the toggle joint with the differently long toggle levers, the desired swiveling movement of the neck support area is achieved with a very simple mechanism.

In one expedient embodiment, the adjustment mechanism is configured in such a way that, during the swiveling movement, the neck support area is swiveled farther forward in the X direction than the head support area. This is achieved in particular by at least one of the asymmetry designs described above.

Preferably, the adjustment mechanism is further configured such that a movement component in the Z direction is at least partially and preferably completely compensated for during the swiveling movement of the neck support area.

As a result of the swiveling movement, the neck support area initially performs a movement that consists of a superposition of movement components in the X direction and in the Z direction, whereby the Z component corresponds to a change in height and the X component to a feed movement toward the user. By at least partially compensating for the movement component in the Z direction that inevitably occurs during the swiveling movement, an undesired displacement of a contact area of the headrest in the Z direction and thus a height adjustment is at least largely and preferably completely avoided. This ensures a high level of comfort, since only a feed movement in the X direction is preferred despite the swiveling movement. The head support area therefore remains at the same height during the swiveling movement. This is perceived as particularly pleasant, because the compensation means that the neck support does not rub against the user's neck, which is perceived as unpleasant.

The head and neck support is generally linked to the support via a swivel arm, particularly to an adjustment element. Specifically, the swivel arm is embodied as a toggle lever and is part of the afore-described toggle lever mechanism, and the adjustment element is one of the afore-described adjustment elements, in particular the upper adjustment element.

At least one adjustment element can generally be moved in the Z direction. For the desired compensation for the movement component in the Z direction, at least this one adjustment element is specifically moved in such a way that the movement component in the Z direction occurring during the swiveling movement is compensated for, i.e., reduced.

By specifically controlling the movement sequence, a pivot point of the swivel arm on the adjustment element is moved during the swiveling movement, particularly in the Z direction. At this pivot point, the swivel arm is usually attached to the adjustment element in a hinged manner and is mounted so that it can pivot around the axis of rotation. The axis of rotation is formed in particular by the swivel bearing described above. The compensation is therefore achieved substantially by a suitable shifting of the swivel axis in the Z direction. The displacement in the Z direction is such that it counteracts the movement component of the swiveling movement in the Z direction.

In the preferred embodiment with the toggle lever mechanism, at least the upper adjustment element is moved. Preferably, both adjustment elements are moved in a controlled manner in order to achieve the desired compensation.

The adjustment mechanism generally has a control device via which the adjustment movements are controlled. This is therefore used to control the at least one electric motor drive.

Now, the control device is configured such that the adjustment movement of the at least one adjustment element is controlled in a targeted manner and, in particular, the adjustment movements of both adjustment elements are coordinated with one another so that the desired compensation is achieved.

In a preferred embodiment, in addition to the adjustment mechanism for the joint height adjustment and swivel adjustment, an additional adjustment mechanism is provided for a linear adjustment movement forward of at least the neck support area in the direction of the user and thus in particular in the X direction. Preferably, the neck support area and the head support area are moved together using this additional adjustment mechanism. In particular, in addition to the afore-described toggle lever mechanism, there is also an additional adjustment mechanism for linear adjustment toward the front. This provides additional improved adjustment of the combined head and neck support. This additional adjustment mechanism is preferably coupled to the neck support area and the head support area in such a way that it moves together with them in the Z direction when the height is adjusted.

In principle, different designs are possible for this additional adjustment mechanism, for example with the aid of a linear guide and/or with a swivel mechanism, with a slotted guide, or combinations thereof.

In one expedient embodiment, the joint height adjustment and swivel adjustment are driven by an electric motor, meaning that electric drives are provided for the adjustment movements. For example, two coordinated drives are provided for this purpose which drive the afore-described adjustment elements of the toggle lever mechanism independently of each other.

Other features which are considered as characteristic for the invention are set forth in the appended claims.

Although the invention is illustrated and described herein as embodied in an adjustable head and neck support, and a vehicle seat, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, partial side view of a vehicle seat with a user sitting in it in an upper area of a backrest with an adjustable head and neck support in a home position;

FIG. 2 is a partial side view similar to FIG. 1, but with the head and neck support swiveled relative to the home position; and

FIG. 3 is a partial side view similar to FIG. 1, the head and neck support being shown having been moved into a forwardly extended position by means of an additional adjustment mechanism.

### DETAILED DESCRIPTION OF THE INVENTION

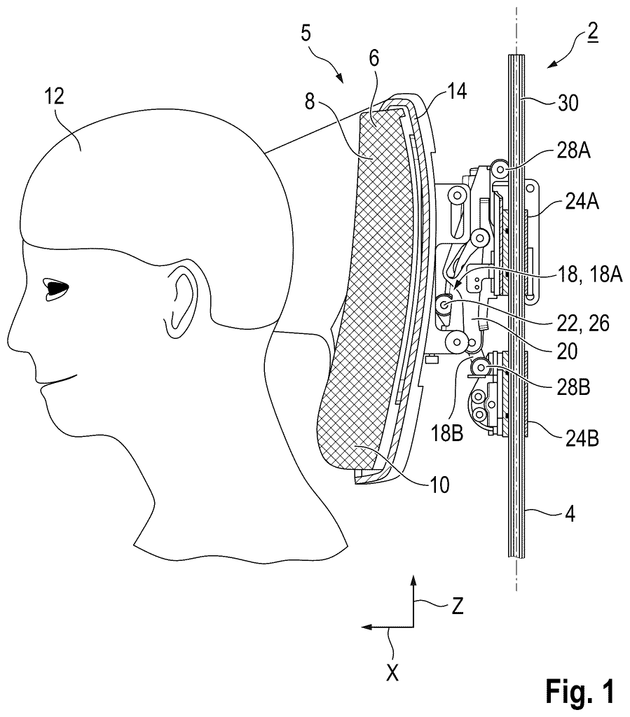

Referring now to the figures of the drawings in detail and first, particularly to FIG. 1 thereof, there is shown a vehicle seat 2, shown only partially in the figures, comprises a backrest 4 and a head and neck support 5 with a combined support unit 6. In a one-piece or integral design, this has a head support area 8 and a neck support area 10. This is located at the lower end of the head support area 8. Preferably, but not necessarily, the neck support area 10 bulges forward in an X direction and thus in the direction of a user 12 located in the vehicle seat 2. In the exemplary embodiment, the head and neck support 5 is configured to be concavely curved overall, so that it curves slightly forward in the neck support area 10.

In the exemplary embodiment, a design variant is shown in which a head and neck support 5 is integrated into an upper portion of the backrest 4. Alternatively, a mounted design is also possible in which the head and neck support 5 is connected to the actual backrest 4 by means of at least one guide element, for example guide rods.

The combined support unit 6 has a support 14 which is formed, for example, by a rear wall of the combined support unit 6 that is oriented in the direction of the backrest 4. The head support area 8 and the neck support area 10 are formed, for example, by a suitable cushion which is attached to this support 14 and shown by hatching in the figures.

The backrest 4 extends upward along a Z direction. Perpendicular to this Z direction, an X direction is defined which is oriented toward the user 12. Furthermore, a transverse direction or Y direction is defined which is oriented perpendicular to the Z direction and perpendicular to the X direction and thus perpendicular to the drawing plane in the figures.

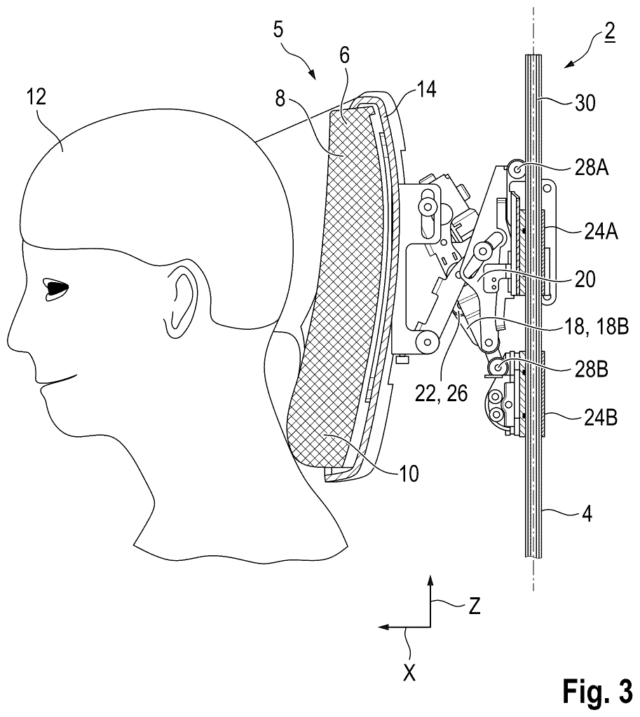

The adjustment of this combined support unit 6 is carried out by means of an adjustment mechanism which, in the exemplary embodiment, has multiple, in particular two, adjustment mechanisms. In the exemplary embodiment, one adjustment mechanism is embodied as a toggle lever mechanism 18 for height adjustment and swivel adjustment, and a further, additional adjustment mechanism 20 is configured for a linear adjustment movement forward in the direction of the user 12. The linear adjustment movement takes place—at least in the unswivelled positions shown in FIG. 1 or FIG. 3—in the X direction and thus perpendicular to the Z direction. In the exemplary embodiment, the additional adjustment mechanism 20 is configured in the manner of a scissor mechanism with two crossed scissor levers. This makes a separate linear adjustment of the combined support unit 6 possible independently of the toggle lever mechanism 18. Preferably, two toggle lever mechanisms 18 are arranged opposite one another in the transverse direction. The additional adjustment mechanism 20 is arranged in a space between these two toggle lever mechanisms 18.

Preferably, all adjustment processes described herein can be actuated by an electric motor, meaning that suitable electric motor drives are integrated into the head and neck support 5 via which the various movements are initiated. The two toggle lever mechanisms 18 are driven in particular by a common electric motor.

The toggle lever mechanism 18 has two toggle levers, namely an upper toggle lever 18A and a lower toggle lever 18B, which are connected to one another at a toggle joint 22. The two toggle levers 18A, 18B are each hingedly supported at their other end on an adjustment element, namely an upper adjustment element 24A and a lower adjustment element 24B. The upper toggle lever 18A is pivotably mounted on an upper swivel joint 28A, and the lower toggle lever 18B is pivotably mounted on a lower swivel joint 28B on the respective adjustment element 24A, 24B. The toggle levers 18A, 18B connect the swivel joints 28A, 28B to the toggle joint 22.

The toggle lever mechanism 18 preferably has an asymmetrical design and has toggle levers 18A, 18B of different lengths. In particular, the upper toggle lever 18A is longer than the lower toggle lever 18B. The proportion is at least 60:40, for example. In principle, a smaller difference or equally long toggle levers 18A, 18B are also possible, but this may lead to space and collision problems.

In the exemplary embodiment, the toggle lever mechanism 18—at least in some positions—rests with a linkage area 26 on the rear side of the combined support unit 6, for example on the support 14. The articulation region 26 is formed on the toggle joint 22 or in the vicinity of the toggle joint 22. Like in the exemplary embodiment, the toggle lever mechanism 18 is supported, for example, only loosely on the combined support unit 6 or is alternatively fastened thereto. In the case of loose support, the linkage area 26 therefore does not necessarily in contact in every position. For example, the linkage area 26 is not in contact when the head and neck support 5 is in its extended position in the X direction, as shown in FIG. 3.

The combined support unit 6 is still pivotably mounted in an upper portion on a swivel bearing. In the exemplary embodiment, the swivel bearing is formed by the upper swivel joint 28A. The upper swivel joint 28A is generally arranged at a fixed position with respect to the toggle mechanism 18. It is moved along in the Z direction during a height adjustment.

The two adjustment elements 24A, 24B can be moved in the Z direction along a common linear guide 30, formed for example by a rod, and in particular they are mounted in a (slidingly) displaceable manner. They are therefore configured particularly in the style of a sled. The movement of the adjustment elements 24A, 24B along the linear guide 30 can be carried out jointly and thus in coupled or independent fashion.

For example, for a pure height adjustment in the Z direction, a joint, coordinated displacement of the two adjustment elements 24A, 24B and thus of the entire toggle lever mechanism 18 together with the combined support element 6 and preferably also together with the additional adjustment mechanism 20 is possible, in particular by means of a suitable electromotive control. In this case, the entire combined support unit 6 is only moved in the Z direction for a suitable height adjustment. The angular orientation of the combined support unit 6 and especially of the support 14 in relation to the Z direction therefore remains unchanged.

If, for example, a targeted support of a neck area of the user 12 in a comfortable position is desired, the combined support unit 6 is swiveled about the upper swivel joint 28A through suitable actuation of the toggle lever mechanism 18, thus varying the angular orientations with respect to the Z direction. To perform this swivel adjustment, the two adjustment elements 24A, 24B are actuated in opposite directions, so that the angular position of the two toggle levers 18A, 18B is varied and the toggle joint 22 and thus the linkage area 26 is displaced forward (in the X direction). Due to the arrangement of the upper swivel joint 28A in an upper region, the neck support region 10 is swiveled forward more toward the user 12 than the head support region 8.

In general, the adjustment mechanism is configured such that a relative adjustment takes place between the head support area 8 and the neck support area such that the neck support area is oriented farther forward in the direction of the user 12 after the swivel adjustment in the X direction has been carried out. In one embodiment, for example, a provision is made that only the head support area 8 is swiveled backward, or additionally.

The desired swiveling movement is supported by the asymmetrical design of the toggle lever mechanism 18 with the differently long toggle levers 18A, 18B, in particular by the longer upper toggle lever 18A. Furthermore, the swiveling movement is also facilitated by an asymmetrical connection of the toggle lever mechanism 18 to the combined support unit 6. The toggle lever mechanism 18 is supported in a lower area, specifically on a lower third of the combined support unit 6, namely at the swivel axis 26. This is generally positioned below the upper swivel joint 28A.

The swiveling movement about the axis of rotation or swivel axis defined by the swivel bearing (upper swivel joint 28A) generally results in a swiveling movement that is composed of a superposition of movement components in the Z direction and in an X direction oriented transversely thereto. The X direction indicates the direction from the backrest to a user and is oriented perpendicular to the Z direction.

During this swiveling movement, the adjustment elements 24A, 24B and in particular at least the upper adjustment element 24A are controlled in such a way that the movement component in the Z direction, which inevitably occurs during the swiveling movement, is compensated for, particularly in such a way that the height level of the neck support area 10 is not changed during the swiveling movement.

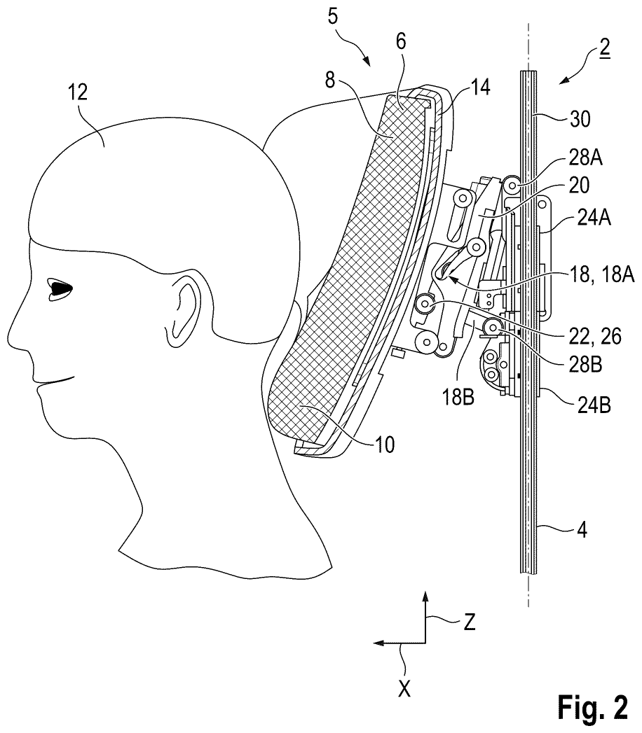

In FIG. 1, the support unit 6 is in a rear position from which it is swiveled forward into a swiveled-out position, as can be seen in FIG. 2. During this swiveling movement, the neck support area 10 would move forward along a circular arc without compensation of the movement component in the Z direction. This would result in a change in the height level of the neck support area 10. To avoid this, the two adjustment elements 24A, 24B and in particular at least the upper adjustment element 24A are suitably moved, and in particular the upper adjustment element 24A is displaced downward in the Z direction. Through this movement, which is opposite to the movement component in the Z direction due to the swiveling movement, this movement component in the Z direction of the swiveling movement is compensated for and balanced out.

In a preferred embodiment, in order to achieve the most complete compensation possible, the lower adjustment element 24B is also suitably controlled at the same time. The neck support area 10 then moves along a straight, preferably horizontal line, in particular without a contact area between the neck support area 10 and the neck of the user sliding along the neck (in the Z direction), which would be perceived as unpleasant.

In addition to this afore-described joint, pure height adjustment in the Z direction and the swivel adjustment, as described for FIG. 2, a (pure) particularly linear feed movement forward and especially in the X direction is also possible with the aid of the additional adjustment mechanism 20, as shown in FIG. 3. In this case, the combined support unit 6 is advanced forward in the X direction, for example starting from the home position shown in FIG. 1.

The additional adjustment mechanism 20 is also suitably connected to the adjustment elements 24A, 24B and thus moves with them for height adjustment in the Z direction.

As can be seen in particular from FIG. 3, in the position extended forward in the X direction, the linkage area 26 does not rest against the combined support unit 6, but is spaced apart from it. The mechanical connection between the backrest 4 and the head and neck support 5 is achieved via the additional adjustment mechanism 20, which is embodied as a scissor mechanism.

The various movement sequences—i.e., the height adjustment in the Z direction, the swivel adjustment, and the linear feed movement forward—can preferably be combined with each other in any combination and can therefore overlap.

The invention is not limited to the exemplary embodiments described above. Rather, other variants of the invention can also be derived therefrom by a person skilled in the art within the scope of the disclosed claims without departing from the subject matter of the claimed invention. In particular, any and all individual features described in connection with the various exemplary embodiments can also be combined in other ways in the framework of the claims without departing from the subject matter of the claimed invention.

The following is a summary list of reference numerals and the corresponding structure used in the above description of the invention:
2 vehicle seat
4 backrest
5 head and neck support
6 combined support unit
8 head support area
10 neck support area
12 user
14 support
18 toggle lever mechanism
18A upper toggle lever
18B lower toggle lever
20 additional adjustment mechanism
22 toggle joint
24A upper adjustment element
24B lower adjustment element
26 linkage area
28A upper swivel joint, swivel bearing
28B lower swivel joint
30 linear guide

1. An adjustable head and neck support, comprising;
a head support area;
a neck support area; and
a common adjustment mechanism and by means of said common adjustment mechanism a coupled movement of said head support area and said neck support area is enabled, wherein said common adjustment mechanism is configured such that a joint height adjustment of said head support area and said neck support area in a Z direction is enabled and, alternatively, only a swivel adjustment of at least one of said neck support area and said head support area is enabled, so that after the swivel adjustment has been carried out, said neck support area is oriented forward in a direction of a user.

2. The adjustable head and neck support according to claim 1, wherein said neck support area has a support whose inclination with respect to the Z direction is changed during the swivel adjustment.

3. The adjustable head and neck support according to claim 1, wherein said head support area and said neck support area are configured in one piece and form a combined support unit.

4. The adjustable head and neck support according to claim 3, further comprising:
a linkage area; and
a swivel bearing, wherein said common adjustment mechanism is linked at least indirectly to said combined support unit via said linkage area and said swivel bearing, wherein for the joint height adjustment in the Z direction said linkage area and said swivel bearing are moved together, and for the swivel adjustment said linkage area is moved forward and said combined support unit is swiveled about said swivel bearing.

5. The adjustable head and neck support according to claim 3,
further comprising adjusting elements; and
wherein said common adjustment mechanism has a toggle lever mechanism with two toggle levers which are connected to one another at a toggle joint and which are each hingedly supported on one of said adjusting elements.

6. The adjustable head and neck support according to claim 5, further comprising a liner guide, wherein said adjusting elements are moved along said linear guide in the Z direction.

7. The adjustable head and neck support according to claim 5, wherein for the joint height adjustment, said adjusting elements are moved jointly with one another in the Z direction.

8. The adjustable head and neck support according to claim 5, wherein for a tilt adjustment, said adjusting elements are moved independently of one another in the Z direction, so that a distance between them is variable.

9. The adjustable head and neck support according to claim 5, wherein said toggle lever mechanism is asymmetrical and said two toggle levers have different lengths.

10. The adjustable head and neck support according to claim 5, wherein said toggle joint is linked asymmetrically to said combined support unit at a lower portion, at least indirectly.

11. The adjustable head and neck support according to claim 1, wherein said common adjustment mechanism is configured such that, during the swivel adjustment, said neck support area is swiveled farther forward than said head support area.

12. The adjustable head and neck support according to claim 1, wherein the adjustable head and neck support is configured such that a movement component in the Z direction is at least partially compensated for during the swiveling movement.

13. The adjustable head and neck support according to claim 5, wherein at least one of said adjusting elements is moved for compensation.

14. The adjustable head and neck support according to claim 1, further comprising an additional adjustment mechanism providing for a linear adjustment of at least said neck support area forward in the direction of the user.

15. The adjustable head and neck support according to claim 1, further comprising an electric motor, wherein the joint height adjustment and the swivel adjustment are driven by said electric motor.

16. A vehicle seat, comprising:
the adjustable head and neck support according to claim 1.
